(19) United States
(12) Patent Application Publication
(10) Pub. No.: US 2024/0317925 A1
(43) Pub. Date: Sep. 26, 2024

(54) URETHANE (METH)ACRYLATE

(71) Applicant: AGC Inc., Tokyo (JP)

(72) Inventors: Makito NAKAMURA, Chiyoda-ku (JP); Chitoshi SUZUKI, Chiyoda-ku (JP)

(73) Assignee: AGC Inc., Tokyo (JP)

(21) Appl. No.: 18/735,272

(22) Filed: Jun. 6, 2024

Related U.S. Application Data
(63) Continuation of application No. PCT/JP2022/043691, filed on Nov. 28, 2022.

(30) Foreign Application Priority Data
Dec. 9, 2021 (JP) 2021-200206

(51) Int. Cl. C08G 18/67; C08G 18/10; C08G 18/32; C08G 18/75; C09D 175/04

(52) U.S. Cl. CPC C08G 18/6755; C08G 18/10; C08G 18/3215; C08G 18/755; C09D 175/04

(57) ABSTRACT

Provided is a urethane (meth)acrylate that has a viscosity excellent in handling and can be cured to form a cured product having a large tensile strength and being excellent in toughness and shape recoverability when folded as well as shape retention. The urethane (meth)acrylate of the present invention is represented by the following formula (1) and having a number average molecular weight (Mn) of 7500 to 60000:

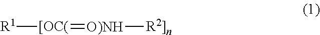

wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol; and n is 3 or more; and a number n of R² per molecule are each independently a residual group formed by removing an isocyanate group from a monoisocyanate having one or more (meth)acryloyloxy groups per molecule.

### TECHNICAL FIELD

The present invention relates to a urethane (meth)acrylate suitable for a coating material and a method for producing the same, a curable composition including the urethane (meth)acrylate, and a cured product thereof.

### BACKGROUND ART

A urethane (meth)acrylate can give a functionalized polymer excellent in various characteristics, including flexibility, toughness, impact resistance, and adhesion, when it is used as a monomer, and thus, the urethane (meth)acrylate is a compound with a high versatility as a monomer. Examples of the application thereof include utilization as an ingredient of a surface protection coating material for preventing scratches, cracks, and the like in a display or touch panel of image displaying devices.

A general method for synthesizing a urethane (meth)acrylate is a method including reacting a prepolymer with a compound having a hydroxy group and a (meth)acryloyloxy group (for example, 2-hydroxyethyl acrylate), wherein the prepolymer is an isocyanate group-terminated prepolymer obtained by reacting a polyol and a polyisocyanate such that the molar ratio of the hydroxy group of the polyol to the isocyanate group of the polyisocyanate is more than 1. Another synthesis method is also known that includes reacting a polyol with a compound having an isocyanate group and a (meth)acryloyloxy group.

The kind of the polyol as a starting material of the urethane (meth)acrylate obtained by any of these synthesis methods greatly affects the difference in the characteristics of cured products obtained by using the urethane (meth)acrylate as a monomer.

For example, Patent document 1 discloses a urethane (meth)acrylate obtained by reacting a prepolymer with 2-hydroxyethyl acrylate, wherein the prepolymer is an isocyanate group-terminated prepolymer having three hydroxy groups and synthesized by using polypropyrene glycol having a molecular weight, in terms of hydroxyl value, of 4000 to 7000.

### CITATION LIST

### Patent Literature

PTL 1: JP 2018-35264 A1

### SUMMARY OF INVENTION

### Technical Problem

For a device having a structure such that its face is to be folded, such as a flexible display or a foldable device, it is necessary to have toughness and shape recoverability when folded.

The urethane (meth)acrylate as disclosed in PTL 1 can form a cured coating with large hardness; however, it cannot be said that it has sufficient toughness or shape recoverability when folded.

The present invention has made under such circumstances, and an object thereof is to provide a urethane (meth)acrylate that has a viscosity excellent in handling and can be cured to form a cured product having a large tensile strength and being excellent in toughness and shape recoverability when folded as well as excellent shape retention.

### Solution to Problem

The present invention is based on a finding that a cured product obtained by using a urethane (meth)acrylate having a structure derived from a specific polyol shows a small residual strain, has favorable toughness and shape recoverability when folded, and also is excellent in shape retention.

The present invention provides the following means.

[1] A urethane (meth)acrylate represented by the following formula (1) and having a number average molecular weight (Mn) of 7500 to 60000:

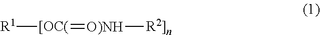

wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol; and n is 3 or more; and a number n of R² per molecule are each independently a residual group formed by removing an isocyanate group from a monoisocyanate having one or more (meth)acryloyloxy groups per molecule.

[2] The urethane (meth)acrylate according to [1], wherein the urethane (meth)acrylate has a ratio of a weight average molecular weight (Mw) to the number average molecular weight (Mn), Mw/Mn, of 1.0 to 1.4.

[3] The urethane (meth)acrylate according to [1] or [2], wherein n is 4 to 10.

[4] The urethane (meth)acrylate according to any one of [1] to [3], wherein the urethane (meth)acrylate is a urethane reaction product between the polyol having a number n of hydroxy groups per molecule and the monoisocyanate, and the polyol having a number n of hydroxy groups per molecule has a molecular weight, in terms of hydroxyl value, of 7500 or more.

[5] The urethane (meth)acrylate according to any one of [1] to [4], wherein the polyol having a number n of hydroxy groups per molecule is a polyether polyol.

[6] The urethane (meth)acrylate according to any one of [1] to [5], wherein the polyether polyol has an oxyalkylene group as a constitutional unit, and the oxyalkylene group includes 50 mass % or more of an oxypropylene group based on 100 mass % of all the oxyalkylene group.

[7] A method for producing a urethane (meth)acrylate, comprising providing a reaction product obtained by a urethane reaction between 1 part by mole of a polyol having a number n of hydroxy groups per molecule and n parts by mole of a monoisocyanate, wherein the urethane (meth)acrylate has a number average molecular weight (Mn) of 7500 to 60000, and is represented by formula (1):

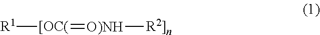

wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol and; and n is 3 or more; and a number n of R² per molecule are each independently a residual group formed by removing an isocyanate group from a monoisocyanate having one or more (meth)acryloyloxy groups per molecule.

[8] The method according to [7], wherein the polyol having a number n of hydroxy groups per molecule has a molecular weight, in terms of hydroxyl value, of 7500 or more.

[9] The method according to [7] or [8], wherein the polyol having a number n of hydroxy groups per molecule is the polyether polyol.

[10] The method according to any one of claims [7] to [9], wherein the polyether polyol has an oxyalkylene group as a constitutional unit, and the oxyalkylene group includes 50 mass % or more of an oxypropylene group based on 100 mass % of all the oxyalkylene group.

[11] A curable composition comprising the urethane (meth)acrylate according to any one of claims [1] to [6].

[12] The curable composition according to [11], wherein a content of the urethane (meth)acrylate in the curable composition is 50 mass % or more.

[13] The curable composition according to or [12], wherein the curable composition is a coating material.

[14] A cured product obtained by curing the curable composition according to any of [11] to [13].

[15] An article comprising the cured product according to [14].

### Advantageous Effects of Invention

According to the present invention, there can be provided a urethane (meth)acrylate that has a viscosity excellent in handling and can be cured to form a cured product having a large tensile strength and being excellent in toughness and shape recoverability when folded as well as shape retention.

Accordingly, the urethane (meth)acrylate of the present invention is useful for application such as a surface protection coating material for, for example, a flexible display or a foldable device.

### DESCRIPTION OF EMBODIMENTS

Definitions and meanings of terms and notation herein are shown below.

“(Meth)acryloyloxy” is a collective term for acryloyloxy and methacryloyloxy. Similarly, “(meth)acryl” is a collective term for acryl and methacryl, and “(meth)acrylate” is a collective term for acrylate and methacrylate.

A number average molecular weight (Mn) and a weight average molecular weight (Mw) are each a molecular weight, in terms of polystyrene, as measured through measurement by gel permeation chromatography (GPC) based on a calibration curve prepared by using a standard polystyrene sample.

The “molecular weight in terms of hydroxyl value” is a value calculated from the formula: 56100×(the number of hydroxyl groups per molecule)/(hydroxyl value [mg KOH/g]). The hydroxyl value can be measured by measurement in accordance with JIS K 1557:2007.

A viscosity is a value as measured at 25° C. using an E-type viscometer.

An “NCO index” is a value, in percent, of an equivalent ratio of the isocyanate group of an isocyanate compound to the hydroxyl group of a polyol.

### [Urethane (Meth)Acrylate]

The urethane (meth)acrylate of the present invention is represented by the following formula (1) and has an Mn of 7500 to 60000:

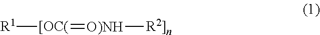

wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol; and n is 3 or more; and a number n of R² per molecule are each independently a residual group formed by removing an isocyanate group from a monoisocyanate having one or more (meth)acryloyloxy groups per molecule.

Such a urethane (meth)acrylate has a skeleton derived from a polyol that has a larger molecular weight than conventional, and has a sharp molecular weight distribution, and accordingly, it is considered that there is a tendency that a cured product obtained by using it as a monomer has a uniform crosslinking network formed therein. Thus, although the urethane (meth)acrylate has a large molecular weight, it has a relatively low viscosity excellent in handling and can also be cured to form a cured product having a large tensile strength, a large storage shearing elastic modulus, and a small residual strain, and being excellent in toughness and shape recoverability when folded as well as shape retention.

The urethane (meth)acrylate of the present invention is the compound represented by formula (1) described above.

The urethane (meth)acrylate is preferably a urethane acrylate in view of rapid polymerization.

### (R¹)

In formula (1), R¹ is an n-valent residual group formed by removing a hydroxy group from a polyol having a number n of hydroxy groups per molecule, the polyol is selected from the group consisting of a polyether polyol, a polyester polyol, and a polycarbonate polyol; and n is 3 or more.

In a case where the polyol is composed of a plurality of types, n is the average number of hydroxy groups per molecule calculated on the basis of the respective contents of the polyols.

The polyol has 3 or more hydroxy groups, preferably 4 to 10 hydroxy groups, more preferably 4 to 8 hydroxy groups, per molecule. In a cured product from the urethane (meth)acrylate having a skeleton derived from a polyol having such a number of the hydroxy groups, a crosslinking network with a high density is formed, whereby favorable shape retention can be easily obtained.

When the number of the hydroxy groups is 4 or more, it is easy to obtain a cured product from the urethane (meth)acrylate that has a large storage shearing elastic modulus, a large tensile strength, and a large hardness of the surface. A cured product from a urethane (meth)acrylate having a skeleton derived from a polyol having 10 or less hydroxy groups has more favorable shape retention.

The polyol is preferably a polyether polyol in view of more favorable shape recoverability, when folded, of a cured product obtained from the urethane (meth)acrylate.

### <Polyether Polyol>

The polyether polyol is preferably a polymer having 3 or more hydroxy groups and also having an oxyalkylene group as a constitutional unit. The polyether polyol can be obtained by ring-opening polymerization of a compound having a cyclic ether structure with an initiator having 3 or more active hydrogen atoms. A commercially available product can also be used. The polyether polyols may be one or two or more.

The oxyalkylene group preferably contains a linear or branched alkylene group having 1 to 14 carbon atoms, and more preferably 2 to 4 carbon atoms. A single kind of an oxyalkylene group may be included, or two or more kinds of oxyalkylene groups may be included.

Specifically, the oxyalkylene group is preferably one or more selected from the group consisting of an oxyethylene group, an oxypropylene group, and an oxytetramethylene group, and more preferably includes an oxypropylene group. In view of favorable toughness of a cured product of the urethane (meth)acrylate, the oxyalkylene group preferably includes 50 mass % or more, more preferably 60 to 100 mass %, even more preferably 80 to 100 mass %, further more preferably 100 mass % of the oxypropylene group, based on 100 mass % of all the oxyalkylene group.

It is considered that the content of the oxypropylene group in all the oxyalkylene group corresponds to the amount, in parts by mass, of propylene oxide blended per total 100 parts by mass of starting materials serving as the sources the oxyalkylene group when synthesizing the polyether polyol.

Examples of the compound having a cyclic ether structure include ethylene oxide, propylene oxide, 1,2-butylene oxide, 2,3-butylene oxide, methyl glycidyl ether, butyl glycidyl ether, 2-ethylhexyl glycidyl ether, lauryl glycidyl ether, hexyl glycidyl ether, and tetrahydrofuran. Among these, ethylene oxide and propylene oxide are preferable.

Examples of a group having the active hydrogen atoms in the initiator include a hydroxyl group, a carboxy group, an amino group having a hydrogen atom bonded to a nitrogen atom. Among these, a hydroxyl group is preferable, and an alcoholic hydroxyl group is more preferable.

Examples of the initiator having 3 or more active hydrogen atoms include a polyol such as glycerin, trimethylolethane, trimethylolpropane, 1,2,6-hexanetriol, pentaerythritol, diglycerin, dipentaerythritol, sorbitol, sucrose, polyoxyalkylene polyol (polyoxyethylene polyol, polyoxypropylene polyol), and triethanolamine; and an amine such as ethylenediamine and diethylenetriamine. Among these, a polyol is preferable, a polyoxyalkylene polyol is more preferable, and polyoxypropylene polyol is even more preferable. The initiator having 3 or more active hydrogen atoms may be used singly or in combinations of two or more thereof.

The initiator may contain a glycol. Examples of the glycol include ethylene glycol, propylene glycol, diethylene glycol, dipropylene glycol, butylene glycol, 1,4-butanediol, 1,6-hexanediol, 3-methyl-1,5-pentanediol, triethylene glycol, tripropylene glycol, and polyoxyalkylene diol. The glycols for combining with the initiator having 3 or more active hydrogen atoms may be used singly or in combinations of two or more thereof.

In a case where the initiator having 3 or more active hydrogen atoms includes the glycol, it is preferable to combine the glycol with an initiator having 4 or more active hydrogen atoms such that n in formula 1 of the urethane acrylate described above is 3 or more. Examples of the initiator having 4 or more active hydrogen atoms include pentaerythritol, dipentaerythritol, sorbitol, and sucrose.

The ring-opening polymerization can be carried out with a known catalyst, including an alkali catalyst such as potassium hydroxide, a transition metal compound/porphyrin complex catalyst such as a complex obtained by reacting an organoaluminum compound with porphyrin, a composite metal cyanide complex catalyst, and a catalyst consisting of a phosphazene compound. Among these catalysts, the double metal cyanide complex (DMC) catalyst is preferable in view of obtaining a polyether polyol having a sharp molecular weight distribution. The double metal cyanide complex catalyst used may be a known compound, and examples thereof include zinc hexacyanocobaltate complex having with tert-butanol as a ligand.

The production of the polyether polyol by ring-opening polymerization with the DMC catalyst may be carried out by a known method, and production methods that can be employed are disclosed in WO 2003/062301, WO 2004/067633, JP 2004-269776 A1, JP 2005-15786 A1, WO 2013/065802, and JP 2015-10162 A1, for example.

### <Polyester Polyol>

The polyester polyol used may be one obtained by a known production method including polycondensation between a polyol including a tri- or higher-functional polyol and a dibasic acid, for example. A commercially available product may also be used.

Examples of the dibasic acid include an aliphatic dibasic acid, such as succinic acid, adipic acid, maleic acid, and fumaric acid: an alicyclic dibasic acid, such as 1.4-cyclohexanedicarboxylic acid; an aromatic dibasic acid, such as phthalic acid, isophthalic acid, and terephthalic acid; and an acid anhydride thereof. The dibasic acids may be used singly or in combinations of two or more thereof.

For the polyol used for the production of the polyester polyol, examples of the tri- or higher-functional polyol include glycerin, trimethylolethane, trimethylolpropane, 1,2,6-hexanetriol, pentaerythritol, diglycerin, dipentaerythritol, sorbitol, sucrose, and polyoxyalkylene polyol (polyoxyethylene polyol, polyoxypropylene polyol). The tri- or higher-functional polyols may be used singly or in combinations of two or more thereof.

The polyol as a starting material for the polyester polyol may include a glycol, and examples of the glycol include ethylene glycol, propylene glycol, diethylene glycol, dipropylene glycol, butylene glycol, 1,4-butanediol, 1,6-hexanediol, 3-methyl-1,5-pentanediol, triethylene glycol, tripropylene glycol, and polyoxyalkylene glycol. The glycols for combining with the tri- or higher-functional polyol may be used singly or in combinations of two or more thereof.

In a case where the polyol includes a glycol, it is preferable to use a tetra- or higher-functional polyol in combination therewith such that n in formula (1) of the urethane acrylate is 3 or more. Examples of the tetra- or higher-functional polyol include pentaerythritol, dipentaerythritol, sorbitol, and sucrose.

### <Polycarbonate Polyol>

The polycarbonate polyol used may be one obtained by a known production method including polycondensation between a polyol including a tri- or higher-functional polyol and a carbonate compound, which is disclosed in JP 2021-59722A, for example. A commercially available product may also be used.

Specific examples of the polyol used for producing the polycarbonate polyol include those listed above as the polyol used for producing the polyester polyol. The tri- or higher-functional polyols may be used singly or in combinations of two or more thereof. Glycols for combining with the tri- or higher-functional polyol may be used singly or in combinations of two or more thereof.

Examples of the carbonate compound include dimethyl carbonate, diethyl carbonate, dipropyl carbonate, dibutyl carbonate, diphenyl carbonate, ethylene carbonate, trimethylene carbonate, propylene carbonate. 1,2-butylene carbonate, and neopentylene carbonate. The carbonate compounds may be used singly or in combinations of two or more thereof.

### (R²)

In formula (1), a number n of R² are each independently a residual group formed by removing an isocyanate group from a monoisocyanate having one or more (meth)acryloyloxy groups per molecule.

R² and R³ may be the same or different from each other. R² and R³ are preferably the same in view of efficiently synthesizing the urethane (meth)acrylate.

### <Monoisocyanate>

The monoisocyanate having a (meth)acryloyloxy groups is preferably a compound having a hydrocarbon skeleton with an isocyanate group and also one or more (meth)acryloyloxy groups bonded to the hydrocarbon skeleton. The number of the (meth)acryloyloxy groups may be one or more.

The hydrocarbon skeleton is preferably an aliphatic hydrocarbon group or an alicyclic hydrocarbon group. The aliphatic hydrocarbon group or alicyclic hydrocarbon group preferably has 8 or less carbon atoms, and more preferably 2 to 6 and even more preferably 2 to 4 carbon atoms.

Examples of the monoisocyanate having a (meth)acryloyloxy groups include a compound having one (meth)acryloyloxy group such as isocyanatomethyl (meth)acrylate and 2-isocyanatoethyl (meth)acrylate; a compound having two (meth)acryloyloxy groups such as 1,1-(bis(meth)acryloyloxymethyl)ethyl isocyanate and 1,1-(bis(meth)acryloyloxymethyl)propyl isocyanate. Examples of a commercially available product thereof include “Karenz (registered trademark; hereinafter, omitting the indication) AOI” (2-isocyanate ethyl acrylate), “Karenz MOI” (2-isocyanate ethyl methacrylate), and “Karenz BEI” (1,1-(bis acryloyloxymethyl)ethyl isocyanate) (all manufactured by Showa Denko K.K.).

### (Number Average Molecular Weight)

The urethane (meth)acrylate has an Mn of 7500 to 60000, preferably 8000 to 55000, and more preferably 8500 to 50000.

When the Mn is within the above-described range, a cured product of the urethane (meth)acrylate has a large tensile strength and is excellent in toughness and shape recoverability when folded as well as shape retention.

The Mw/Mn is preferably 1.0 to 1.4, more preferably 1.02 to 1.38, and even more preferably 1.05 to 1.25.

The Mw/Mn is a measure that indicates a degree of dispersion (broadness) of the molecular weight distribution. A ratio Mw/Mn of 1 indicates monodispersity, and a ratio Mw/Mn closer to 1 means a sharper molecular weight distribution.

When the molecular weight distribution is within the above-described range, the urethane (meth)acrylate has a relatively small viscosity so that a curable composition including thereof is easy to handle in working such as mixing even though the urethane (meth)acrylate has three or more (meth)acryloyloxy groups per molecule and has a molecular weight Mn as large as 7500 or more. In addition, there is a tendency that a uniform crosslinking network is formed in a cured product of the urethane (meth)acrylate, and the cured product has a small residual strain and a large tensile strength and is excellent in toughness and shape recoverability when folded as well as shape retention.

### (Viscosity)

In view of ease in handling, the urethane (meth)acrylate is a liquid at room temperature (25° C.), and preferably has a viscosity at 25° C. of 50 Pas or less, more preferably 40 Pas or less, and even more preferably 30 Pas or less.

### (Urethane Reaction)

The urethane (meth)acrylate of the present invention is obtained as a reaction product of urethane reaction between 1 part by mole of a polyol having a number n of hydroxy groups per molecule and n parts by mole of a monoisocyanate. In other words, the urethane (meth)acrylate is a reaction product between a polyol having a number n of hydroxy groups per molecule and serving as the source of R¹ in formula (1) and a monoisocyanate serving as the source of R².

The polyol preferably has a molecular weight, in terms of hydroxyl value, of 7500 or more, more preferably 8000 to 60000, and even more preferably 8500 to 55000, in view of obtaining an Mn of the urethane (meth)acrylate within the above-described range.

The urethane reaction can be carried out by a known method, and generally, the polyol and the monoisocyanate are mixed with each other, and subjected to the urethane reaction with a catalyst for urethane reaction in a nitrogen gas or inert gas atmosphere.

Examples of the catalyst for urethane reaction include an organotin compound such as dibutyl tin dilaurate, dioctyl tin dilaurate, dibutyl tin dioctoate, and tin 2-ethylhexanoate; an iron compound such as iron acetylacetonate, ferric chloride; a lead compound such as lead 2-ethyl hexanoate; a bismuth compound such as bismuth 2-ethyl hexanoate; and a tertiary amine such as triethylamine and triethylenediamine. Among these, the organotin compound, lead 2-ethylhexanoate, and bismuth 2-ethyl hexanoate are preferable. The catalysts for urethane reaction may be used singly or in combinations of two or more thereof.

The amount of the catalyst used for urethane reaction is preferably 0.001 to 1 part by mass, more preferably 0.002 to 0.5 part by mass, and even more preferably 0.005 to 0.1 part by mass, per 100 parts by mass of the polyol as a reactant.

The reaction temperature of the urethane reaction is preferably 20 to 100° C., more preferably 30 to 90° C., and even more preferably 40 to 80° C.

### [Curable Composition]

The curable composition of the present invention includes the urethane (meth)acrylate of the present invention described above.

In the curable composition, a polymerization initiator and other components, if necessary, are preferably contained.

The content of the urethane (meth)acrylate in the curable composition is preferably 50 mass % or more, more preferably 70 mass % or more and 100 mass % or less, and even more preferably 80 mass % or more and 100 mass % or less, in view of obtaining a cured product excellent in toughness.

It is preferable to uniformly mix the components to be contained in the curable composition, and for example, they can be mixed using a known mixer such as a planetary agitator/deaerator, a homogenizer, a planetary mixer, a three-roll mill, and a bead mill. The components to be contained may be mixed all at once, or mixed while added successively.

### (Polymerization Initiator)

The polymerization initiator is preferably a radical polymerization initiator, which may be a photo polymerization initiator or a thermal polymerization initiator, and any known initiator can be used.

In view of ease in controlling the polymerization reaction, the photo polymerization initiator is preferably one rendered usable by irradiation with ultraviolet rays having a wavelength of 380 nm or less, and the thermal polymerization initiator is preferably one rendered usable by heating at a temperature within a range from 50 to 120° C.

Examples of the photo polymerization initiator include 1-hydroxycyclohexylphenyl ketone, 2-hydroxy-2-methylpropiophenone, diethoxyacetophenone, 1-(4-isopropylphenyl)-2-hydroxy-2-methylpropanone, 1-(4-dodecylphenyl)-2-hydroxy-2-methylpropanone, 4-(2-hydroxyethoxy)-phenyl(2-hydroxy-2-propyl)ketone, 2-methyl-1-[4-(methylthio)phenyl]-2-morpholinopropanone, benzoin, benzoin methyl ether, benzoin ethyl ether, benzoin isopropyl ether, benzoin n-butyl ether, benzoin phenyl ether, benzyl dimethyl ketal, benzophenone, benzoyl benzoate, methyl benzoyl benzoate, 4-phenylbenzophenone-4-methoxybenzophenone, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, 2,4,6-trimethylbenzoyl diphenylphosphine oxide, phenylbis(2,4,6-trimethylbenzoyl)phosphine oxide, methylphenyl glyoxylate, benzyl, and camphorquinone. The photo polymerization initiators may be used singly or in combinations of two or more thereof.

Examples of the thermal polymerization include an azo compound; and an organic peroxide such as hydroperoxide, dialkyl peroxide, peroxyester, diacyl peroxide, peroxydicarbonate, peroxiketal, and ketone peroxide. Specific examples include azobisisobutyronitrile, benzoyl peroxide, tert-butyl peroxy-2-ethylhexanoate, 2,5-dimethyl-2,5-di(2-ethylhexanoyl)peroxyhexane, tert-butyl peroxybenzoate, tert-butyl peroxide, cumene hydroperoxide, dicumylperoxide, di-t-butylperoxide, 2,5-dimethyl-2,5-dibutylperoxyhexane, 2,4-dichlorobenzoyl peroxide, 1,4-di(2-t-butylperoxyisopropyl)benzene, 1,1-bis(tert-butylperoxy)-3.3,5-trimethylcyclohexane, methyl ethyl ketone peroxide, and 1,1,3,3-tetramethyl butyl peroxy-2-ethyl hexanoate. The thermal polymerization initiators may be used singly or in combinations of two or more thereof.

The content of the polymerization initiator in the curable composition is preferably 0.001 to 20 parts by mass, more preferably 0.01 to 10 parts by mass, and even more preferably 0.1 to 7 parts by mass, per 100 parts by mass of the urethane (meth)acrylate, in view of the moderate rate of the polymerization.

In a case where the curable composition is irradiated with light to obtain a cured product, the light source can be appropriately selected according to the light absorptivity of the photo polymerization initiator contained. Examples of the light source that can be used include a UV light-emitting diode (LED), a low-pressure mercury lamp, a high-pressure mercury lamp, a mercury xenon lamp, a metal halide lamp, a tungsten lamp, an arc lamp, an excimer lamp, an excimer laser, a semiconductor laser, a YAG laser, a laser systems including combinations of a laser and a non-linear optical crystal, and a high frequency-induced, UV light-generating device. The cumulative dose of light may be about 0.01 to 50 J/cm², for example.

After the irradiation with light, heat treatment may further be carried out to more stabilize the physical properties of the cured product. Generally, the heating temperature is about 40 to 200° C., and the heating time is about 1 minute to 15 hours. The physical properties of the cured product can also be stabilized by still standing it at room temperature (about 15 to 25° C.) for about 1 to 48 hours.

In a case where the curable composition is subjected to heat treatment to obtain a cured product, the heating temperature is about 40 to 250° C., and the heating time is about 5 minutes to 24 hours, generally. Preferably, the heating time is shorter when the heating temperature is higher, and the heating time is longer when the heating temperature is lower.

### (Other Components)

The curable composition may include other components, in addition to the urethane (meth)acrylate and the polymerization initiator, in view of ease in handling and according to its application. Examples of the other components include a monomer component other than the urethane (meth)acrylate of the present invention, a catalyst, a colorant such as a pigment and a dye, a silane coupling agent, a tackifier resin, an antioxidant, a light stabilizer, a metal deactivator, an anti-rust agent, an anti-aging agent, a moisture absorbent, a hydrolysis inhibitor, a defoaming agent, and a filler. A solvent may also be included. These other components in the curable composition can be blended in the content range such that the effect of the present invention is not impaired.

The other monomer component is a compound that is copolymerizable with the urethane (meth)acrylate, and examples thereof include a (meth)acrylate such as a urethane (meth)acrylate other than the urethane (meth)acrylate of the present invention, an alkyl (meth)acrylate, a hydroxyl-containing (meth)acrylate, and an amino-containing (meth)acrylate. The other monomer components may be used singly or in combinations of two or more thereof.

The curable composition including the urethane (meth)acrylate of the present invention is suitable for application to a coating material for various base materials, among others, a surface protection coating material for preventing scratches, cracks, and the like in a display or touch panel of image displaying devices, for example. Particularly, the cured product of the curable composition has a large tensile strength and is excellent in toughness and shape recoverability when folded as well as shape retention; accordingly, the curable composition is suitable for a surface protection coating material for, for example, a flexible display or a foldable device.

### [Cured Product]

The cured product of the present invention is obtained by curing the curable composition including the urethane (meth)acrylate described above. The cured product has a large tensile strength, a large storage shearing elastic modulus, and a small residual strain, and is excellent in toughness and shape recoverability when folded as well as shape retention.

Therefore, since these characteristics are exhibited in the applications as described above, there can be suitably provided, according to the present invention, coated articles including the cured product of the present invention, particularly articles, such as a flexible display or a foldable device, having a surface coated with the cured product of the present invention.

### EXAMPLES

The present invention will now be specifically described by way of Examples; however, the present invention is not limited to Examples below and various changes can be made without departing from the spirit of the present invention.

### [Compounds as Starting Materials]

Details of the various compounds used as starting materials in Examples were as follows.
DMC-TBA: Zinc hexacyanocobaltate-tert-butanol complex
Initiator A: polyoxypropylene tetraol obtained by ring-opening polymerization of propylene oxide (hereinafter abbreviated to as “PO”) with pentaerythritol (molecular weight, in terms of hydroxyl value, 1200)
Initiator B: polyoxypropylene hexaol obtained by ring-opening polymerization of PO with sorbitol (molecular weight, in terms of hydroxyl value. 880)
Initiator C: polyoxypropylene triol obtained by ring-opening polymerization of propylene oxide with glycerin (molecular weight, in terms of hydroxyl value, 1000)
PPG (1): polypropylene glycol: “EXCENOL (registered trademark) 1020,” manufactured by AGC Inc.; hydroxyl value 112.2 mg KOH/g; molecular weight, in terms of hydroxyl value, 1000)
AOI: 2-acryloyloxyethyl isocyanate; “Karenz (registered trademark) AOI,” manufactured by Showa Denko K.K.
Isophorone diisocyanate: “Desmodur (registered trademark) I,” manufactured by Sumika Covestro Urethane Co., Ltd.
2-Hydroxyethyl acrylate, manufactured by Tokyo Chemical Industry Co., Ltd.
2,5-Di-tert-butylhydroquinone, manufactured by Tokyo Chemical Industry Co., Ltd., antioxidant
Polyol (8): polyoxyalkylene triol; “EXCENOL (registered trademark) 3030,” manufactured by AGC Inc.; hydroxyl value 56.1 mg KOH/g; molecular weight, in terms of hydroxyl value,
Photo polymerization initiator: phenylbis(2,4,6-trimethylbenzoyl)phosphine oxide; “Irgacure (registered trademark) 819,” manufactured by BASF SE

### [Measurement Methods]

The methods for determining various characteristics in Synthesis Examples and Production Examples described later were as follows.

### (Hydroxyl Value)

The hydroxyl value was measured in accordance with B method (automated potentiometric titration) in JIS K1557-1: 2007.

### (Molecular Weight in Terms of Hydroxyl Value)

The molecular weight in terms of hydroxyl value was calculated by the following equation from the found hydroxyl value (unit: mg KOH/g) measured as above (molecular weight of potassium hydroxide 56.1).

Molecular weight in terms of hydroxyl value=56.1×1000×(number of hydroxyl groups per molecule)/(hydroxyl value)

As the number of hydroxyl groups per molecule, the number of hydroxyl groups per molecule of the initiator used for the synthesis of the polyol was used.

### (Number Average Molecular Weight (Mn) and Weight Average Molecular Weight (Mw))

The Mn and Mw of urethane acrylate were measured (in terms of polystyrene) by gel permeation chromatography (GPC) in the following conditions for measurement, and the molecular weight distribution (Mw/Mn) was calculated from these values.

### <Conditions for Measurement>

Apparatus used: “HLC-8320GPC,” manufactured by Tosoh Corporation
Column used: The following two types of columns were connected in series.
   “TSKgel (registered trademark) SuperHM-H,” manufactured by Tosoh Corporation, two columns
   “TSKgel (registered trademark) SuperH2000,” manufactured by Tosoh Corporation, one column
Column temperature: 40° C.
Detector: differential refractive index (RI) detector
Eluent: tetrahydrofuran
Flow rate: 0.8 mL/min
Concentration of sample: 0.5 mass %
Volume of sample injected: 100 μL
Standard sample: Polystyrene

### (Content of Isocyanate Groups)

The content of isocyanate groups (NCO) was quantitatively measured by reverse titration through indicator titration using a method in accordance with A method in JIS K 1603-1: 2007.

### Synthesis of Polyols

### Synthesis Example 1

In a pressure-resistant reactor equipped with a stirrer and a nitrogen introducing tube, 0.8 g of DMC-TBA and 1200 g of initiator A were charged, and 30800 g of PO was added at a constant rate over 30 hours in nitrogen gas atmosphere at 130° C. It was checked that the decrease of the inner pressure ceased in the pressure-resistant reactor, and polyol (1) was thus obtained (polyoxypropylene tetraol: hydroxyl value 7.7 mg KOH/g, molecular weight in terms of hydroxyl value 29100)).

### Synthesis Example 2

In a pressure-resistant reactor equipped with a stirrer and a nitrogen introducing tube, 0.2 g of DMC-TBA and 880 g of initiator B were charged, and 6620 g of PO was added at a constant rate over 6.5 hours in nitrogen gas atmosphere at 130° C. It was checked that the decrease of the inner pressure ceased in the pressure-resistant reactor, and polyol (2) was thus obtained (polyoxypropylene hexaol: hydroxyl value 44.2 mg KOH/g, molecular weight in terms of hydroxyl value 7600).

### Synthesis Example 3

Polyol (3) (polyoxypropylene hexaol: hydroxyl value 8.5 mg KOH/g, molecular weight in terms of hydroxyl value 39600) was obtained in the same manner as in Synthesis Example 2, except that the amount of PO added in Synthesis Example 2 was changed to 41120 g.

### Synthesis Example 4

In a pressure-resistant reactor equipped with a stirrer and a nitrogen introducing tube, 0.26 g of DMC-TBA and 1000 g of initiator C were charged, and 9000 g of PO was added at a constant rate over 9 hours in nitrogen gas atmosphere at 130° C. It was checked that the decrease of the inner pressure ceased in the pressure-resistant reactor, and polyol (4) was thus obtained (polyoxypropylene triol: hydroxyl value 17.0 mg KOH/g, molecular weight in terms of hydroxyl value 9900).

### Synthesis Example 5

Polyol (5) (polyoxypropylene triol: hydroxyl value 33.7 mg KOH/g, molecular weight in terms of hydroxyl value 5000) was obtained in the same manner as in Synthesis Example 4, except that the amount of PO added in Synthesis Example 4 was changed to 4120 g.

### Synthesis Example 6

In a pressure-resistant reactor equipped with a stirrer and a nitrogen introducing tube, 0.2 g of DMC-TBA and 400 g of PPG (1) as an initiator were charged, and 6200 g of PO was added at a constant rate over 7 hours in nitrogen gas atmosphere at 130° C. It was checked that the decrease of the inner pressure ceased in the pressure-resistant reactor, and polyol (6) was thus obtained (polypropylene glycol: hydroxyl value 7.5 mg KOH/g, molecular weight in terms of hydroxyl value 15000)).

### Synthesis Example 7

Polyol (7) (polypropylene glycol: hydroxyl value 11.2 mg KOH/g, molecular weight in terms of hydroxyl value 10000) was obtained in the same manner as in Synthesis Example 6, except that the amount of PO added in Synthesis Example 6 was changed to 4100 g.

### Production of Urethane Acrylate

### Production Example 1

In a reactor equipped with a stirrer and a nitrogen introducing tube, 200 g of polyol (1) and 3.9 g of AOI (NCO index 100) were charged, and reacted in the presence of 16 mg of bismuth 2-ethylhexanoate (0.008 parts by mass per 100 parts by mass of polyol (1)) at 70° C. for 3 hours. Then 60 mg of 2,5-di-tert-butylhydroquinone (0.03 ppm by mass per 100 parts by mass of polyol (1)) was added thereto to obtain urethane acrylate (1) (Mn 32000, Mw/Mn 1.23).

### Production Examples 2 to 6

Urethane acrylates (2) to (6) were obtained in the same manner as in Production Example 1, except that polyol (1) used in Production Example 1 was replaced with polyols (2) to (6), respectively.

### Production Example 7

In a reactor equipped with a stirrer and a nitrogen introducing tube, 200 g (0.02 mol) of polyol (7) and 8.9 g (0.04 mol) of isophorone diisocyanate were charged, and reacted in the presence of 16 mg of bismuth 2-ethylhexanoate (0.008 parts by mass per 100 parts by mass of polyol (7)) at 80° C. After it was checked that the content of isocyanate groups reached the theoretical value (0.81 mass %), 4.6 g (0.04 mol) of 2-hydroxyethyl acrylate was added thereto, and the reaction was carried out until the NCO content reached 0 mass %. Then, 60 mg of 2,5-di-tert-butylhydroquinone (0.03 ppm by mass per 100 parts by mass of polyol (7)) was added thereto to obtain urethane acrylate (7).

### Production Example 8

Urethane acrylate (8) was obtained in the same manner as in Production Example 7, except that polyol (7) used in Production Example 7 was replaced with polyol (8) (the blending molar ratio of polyol (8)/isophorone diisocyanate/2-hydroxyethyl acrylate: 1/3/3).

### Production of Curable Composition and Cured Product Thereof

### Examples 1 to 8

By using urethane acrylates (1) to (8) obtained in Production Examples 1 to 8, respectively, curable compositions and cured products thereof were produced, and measurement and evaluation for the items below were carried out.

The curable composition was prepared by mixing 100 parts by mass of a urethane acrylate with 0.3 parts by mass of a photo polymerization initiator.

Results of the measurement and evaluation are shown in Table 1. Examples 1 to 4 are inventive examples, and Examples 5 to 8 are comparative examples.

### [Items of Evaluation]

### (Viscosity)

The viscosity of each of the urethane acrylates was measured using an E-type viscometer (“RE85U” manufactured by TOKISANGYO, 25° C.).

When the viscosity is 30 Pa·s or less, the urethane acrylates is easy to handle in production of a curable composition and a cured product thereof. A case where the viscosity was 30 Pads or less was graded as “A”, and a case where the viscosity was more than 30 Pas was graded as “B”. The results of the grade are shown in Table 1.

### (Tensile Strength)

The curable composition was applied to the releasable surface of a PET film that had been silicone release-treated, to a thickness of 100 μm with an applicator. Then, the curable composition was cured using a conveyer-type UV irradiation system (manufactured by ORC MANUFACTURING CO., LTD.; mercury xenon lamp, intensity of illumination 100 mW/cm², cumulative dose of light 3 J/cm²) to prepare a test sample for tensile test.

The tensile test was conducted on the test sample in accordance with JIS K 7311: 1995 using a tension testing machine (TENSILON universal testing machine “RTG-1310,” manufactured by A&D COMPANY. Limited; tension rate 300 mm/min) to measure the tensile breaking strength (tensile strength).

A case where the tensile strength was 1.0 MPa or more was graded as “A”, and a case where the tensile strength was less than 1.0 MPa was graded as “B”. The results of the grade are shown in Table 1.

### (Storage Shearing Elastic Modulus)

The curable composition was filled and hold in a 0.2-mm gap between a soda-lime glass made stage and a measurement spindle (“disposable plate D-PP20/AL/S07.” manufactured by Anton Paar GmbH). The curable composition was irradiated with UV for 300 seconds in nitrogen gas atmosphere at 35° C. using a mercury xenon lamp (“Spot-Cure (registered trademark) SP-9.” manufactured by Ushio Inc., intensity of illumination 100 mW/cm²) placed under the stage, to thereby obtain a cured product sample of the curable composition. While the curable composition was cured, the position of the spindle was follow-up controlled so as not to generate a stress in the normal direction of the spindle.

While the cured product sample was irradiated with UV, the storage shearing elastic modulus of the cured product sample was measured using a rheometer (“Physica MCR301,” manufactured by Anton Paar GmbH, 1% dynamic shear strain applied).

It can be said that as the storage shearing elastic modulus is higher, the cured product is tougher and also has more favorable shape retention. A case where the storage shearing elastic modulus of the cured product was 500 kPa or more was graded as “A”, and a case where the storage shearing elastic modulus was less than 500 kPa was graded as “B”. The results of the grade are shown in Table 1.

### (Residual Strain)

To a cured product sample prepared in the same manner as for that for measuring the storage shearing elastic modulus, a 2% dynamic shear strain was applied for 30 minutes, and then the strain was released. The residual strain 30 minutes after releasing the strain was measured using a rheometer (“Physica MCR301,” manufactured by Anton Paar GmbH). The residual strain was expressed relatively to that before applying the dynamic shear strain, which was regarded as 0% strain (reference).

It can be said that as the residual strain is smaller, the cured product has more favorable shape recoverability when folded and also has favorable shape retention. A case where the residual strain of the cured product was 0.1% or less was graded as “A”, and a case where the residual strain was more than 0.1% was graded as “B”. The results of the grade are shown in Table 1.

TABLE 1

| Example | | 1 | 2 | 3 | 4 | 5 | 6 | 7 | 8 |
|---|---|---|---|---|---|---|---|---|---|
| Polyol | | (1) | (2) | (3) | (4) | (5) | (6) | (7) | (8) |
| Hydroxyl value | | 4 | 6 | 6 | 3 | 3 | 2 | 2 | 3 |
| Molecular weight, in | | 29100 | 7600 | 39600 | 9900 | 5000 | 15000 | 10000 | 3000 |
| terms of hydroxyl value | | | | | | | | | |
| Urethane acrylate | | (1) | (2) | (3) | (4) | (5) | (6) | (7) | (8) |
| Mn | | 32000 | 9000 | 34900 | 12500 | 8000 | 19500 | 18900 | 8900 |
| Mw/Mn | | 1.12 | 1.17 | 1.23 | 1.14 | 1.08 | 1.11 | 1.34 | 1.32 |
| Viscosity | [Pa · s] | 28 | 3 | 25 | 5 | 1 | 16 | 58 | 26 |
| | | A | A | A | A | A | A | B | A |
| Cured product | | | | | | | | | |
| Tensile strength | [MPa] | 1.5 | 1.1 | 1.3 | 1.3 | 0.9 | 0.9 | 2.3 | 3.1 |
| | | A | A | A | A | B | B | A | A |
| Storage shearing | [kPa] | 625 | 2260 | 552 | 950 | 1550 | 355 | 819 | 2960 |
| elastic modulus | | | | | | | | | |
| | | A | A | A | A | A | B | A | A |
| Residual strain | [%] | −0.01 | 0.04 | −0.03 | 0.01 | 0.01 | 0.02 | −0.02 | 0.17 |
| | | A | A | A | A | A | A | A | B |

As can be seen from the evaluation results shown in Table 1, the urethane acrylates of the present invention (Examples 1 to 4) each had a low viscosity, and therefore favorable handling workability. Also, the cured products of the curable compositions including the urethane acrylates of the present invention (Examples 1 to 4) each had a large tensile strength, a large storage shearing elastic modulus, and a small residual strain, and it can thus be said that the cured products are excellent in toughness, shape recoverability when folded, as well as shape retention.

1. A urethane (meth)acrylate represented by the following formula (1) and having a number average molecular weight (Mn) of 7500 to 60000: 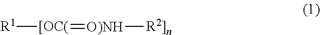
wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol; and n is 3 or more; and
a number n of R² per molecule are each independently a residual group formed by removing an isocyanate group from a monoisocyanate having one or more (meth)acryloyloxy groups per molecule.

2. The urethane (meth)acrylate according to claim 1, wherein the urethane (meth)acrylate has a ratio of a weight average molecular weight (Mw) to the number average molecular weight (Mn), Mw/Mn, of 1.0 to 1.4.

3. The urethane (meth)acrylate according to claim 1, wherein n is 4 to 10.

4. The urethane (meth)acrylate according to claim 1, wherein the urethane (meth)acrylate is a urethane reaction product between the polyol having a number n of hydroxy groups per molecule and the monoisocyanate, and
the polyol having a number n of hydroxy groups per molecule has a molecular weight, in terms of hydroxyl value, of 7500 or more.

5. The urethane (meth)acrylate according to claim 1, wherein the polyol having a number n of hydroxy groups per molecule is a polyether polyol.

6. The urethane (meth)acrylate according to claim 1, wherein the polyether polyol has an oxyalkylene group as a constitutional unit, and the oxyalkylene group comprises 50 mass % or more of an oxypropylene group based on 100 mass % of all the oxyalkylene group.

7. A method for producing a urethane (meth)acrylate, comprising providing a reaction product obtained by a urethane reaction between 1 part by mole of a polyol having a number n of hydroxy groups per molecule and n parts by mole of a monoisocyanate,
wherein the urethane (meth)acrylate has a number average molecular weight (Mn) of 7500 to 60000, and is represented by formula (1): 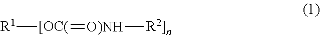
wherein R¹ is an n-valent residual group formed by removing a hydroxy group from a polyol having a number n of hydroxy groups per molecule, the polyol is selected from the group consisting of a polyether polyol, a polyester polyol, and a polycarbonate polyol and; and n is 3 or more; and
a number n of R² per molecule are each independently a residual group formed by removing an isocyanate group from a monoisocyanate having one or more (meth)acryloyloxy groups per molecule.

8. The method according to claim 7, wherein the polyol having a number n of hydroxy groups per molecule has a molecular weight, in terms of hydroxyl value, of 7500 or more.

9. The method according to claim 7, wherein the polyol having a number n of hydroxy groups per molecule is the polyether polyol.

10. The method according to any one of claim 7, wherein the polyether polyol has an oxyalkylene group as a constitutional unit, and the oxyalkylene group comprises 50 mass % or more of an oxypropylene group based on 100 mass % of all the oxyalkylene group.

11. A curable composition comprising the urethane (meth)acrylate according to claim 1.

12. The curable composition according to claim 11, wherein a content of the urethane (meth)acrylate in the curable composition is 50 mass % or more.

13. The curable composition according to claim 11, wherein the curable composition is a coating material.

14. A cured product obtained by curing the curable composition according to claim 11.

15. An article comprising the cured product according to claim 14.
